(19) United States
(12) Patent Application Publication
(10) Pub. No.: US 2014/0313049 A1
(43) Pub. Date: Oct. 23, 2014

(54) SYSTEM AND APPARATUS FOR GRAPHICAL ATHLETIC PERFORMANCE ANALYSIS

(71) Applicant: Madison J. Doherty, Issaquah, WA (US)

(72) Inventor: Madison J. Doherty, Issaquah, WA (US)

(21) Appl. No.: 14/204,937

(22) Filed: Mar. 11, 2014

Related U.S. Application Data
(63) Continuation of application No. 14/059,298, filed on Oct. 21, 2013.
(60) Provisional application No. 61/717,045, filed on Oct. 22, 2012.
(60) Provisional application No. 61/717,058, filed on Oct. 22, 2012.

(51) Int. Cl. A63B 24/00; G06T 11/60

(52) U.S. Cl. CPC A63B 24/0062; G06T 11/60
USPC 340/870.01; 345/632

(57) ABSTRACT

An athletic performance graphical system that measures and translates raw athletic data to computer interpreted performance data and into visual graphics. Athletic equipment is equipped with a performance measuring sensor. In one embodiment, an event announcer uses information gathered from the performance sensor to better explain the sporting event. In one embodiment, a user uses the computer interpreted performance data to measure the growth or improvement of an athlete human or animal.

### CROSS REFERENCE TO RELATED APPLICATIONS

This application is a continuation of U.S. Ser. No. 14/059,298, filed Oct. 21, 2013, which claimed the benefit of priority of U.S. Provisional Patent Application No. 61/717,045 filed Oct. 22, 2012, and U.S. Provisional Patent Application No. 61/717,058 filed Oct. 22, 2012, which are both incorporated herein by reference.

### FIELD OF THE INVENTION

The present invention relates generally to athletic performance systems. More particularly, the present invention relates to turning sensor gathered data from an athletic performance into easy to understand information and visual graphics.

### BACKGROUND OF THE INVENTION

In many instances, a viewer watching an athletic performance has no way to determine the athletic performance other than the outcome of the event. Many times, new viewers of a specific sport get lost in the complexity of the event. Event announcers have access to limited information in order to increase a viewer's understanding. Viewers are unable to determine speed, acceleration, vertical height reached by an athlete among other quantifiable aspects.

To address this problem, sports like professional football have added an on-screen “virtual” yellow line to represent the distance needed for a first down. As well, automobile racing has added graphics that track cars location around the track. Likewise, professional baseball has added strike zone graphics to represent pitch location. While such improvements work well in helping to gain some understanding into the given sport, they are limited in their application and information that can be represented. In addition, no athletic-specific performance data is able to be gathered from this information.

Therefore, there is a need for an athletic graphical mechanism whereby athletic output is transformed into visual graphics that explain velocity, g-force, and other useful quantifiable information.

### SUMMARY OF THE INVENTION

It is an object of the present invention to obviate or mitigate at least one disadvantage of previous athletic graphical mechanisms.

To address the above concerns, the technology disclosed herein relates to a system for measuring athletic performance by capturing performance data via sensors either on an athlete, whether human or non-human (e.g., race horse, bucking bull, greyhound dog, or the like) or on another element used in the given sport (e.g., helmet, uniform, harness, or any suitable sporting equipment.) The present inventive system uses raw output data and using computer analysis automatically generates graphics that are implemented, for example, within a sporting broadcast program.

Generally speaking, the present invention provides for collecting, analyzing and displaying performance data from an athlete to help others (e.g., spectators, commentators, or other interested parties) better understand the mechanics, performance and athletic potential of the given athlete. The data is collected from one or more sensors worn by the athlete during any athletic event. The sensor captures data related to the athlete's geospatial location and records positioning in x,y,z form. That location data is recorded on a memory card within the worn device or stored remotely via transmitting such data in real-time back to a computer processor through cellular transmission or other wireless collection mechanism. The computer processor then uses point of location data along with acceleration and velocity to compute location information. From there, the processed information is compiled into pre-designed performance algorithms such as, but not limited to, height, acceleration, impact force, rate of decline, initial acceleration, initial acceleration and initial force. From a software interface, the user then selects the particular athletic performance to display and using customized software the program exports the data as computer generated television (TV) graphics, statistical reports, email, short-message-service (SMS) or to other devices connected through a server (e.g., remote cloud-based server).

The sensor of the present invention is a sensor module including technology known in the industry which may include, without limitation, a 3-axis accelerometer, 3-axis gyroscope, battery, radio transmission technology and a recording device that records collected data points on digital medium (e.g., a micro SD card) attached to a sensor mother board. It should therefore be understood that the sensor module is equipped with software code written to specifically to record location and acceleration data.

In some embodiments, multiple accelerometers may be placed throughout the athlete's body (i.e., attached via any suitable manner) to collect multiple data points. Each of the additional accelerometers would be connected wirelessly back to the main sensor with any appropriate wireless technology. All addition sensors along with the main sensor would record on a single memory card within the main sensor module.

The data is preferably recorded to a memory card or such suitable local storage, but alternatively may be transmitted through a wireless connection to the computer processor to provide a real-time analysis of the data.

Either wirelessly or manually connecting the sensor module to the sensor data interpretation software allows the software to analyze and compile the data as it is imported. The software determines the position of the device using an algorithm of x,y,z data points and velocity from the accelerometers. In instances where extra accelerometers are used, the software accounts for the mechanical offset of those data points when compiling the data.

At least one base computer will receive and analyze the data. This computer may be programmed to analyze, collate, collect, compare, interpret, create visual graphics, export to performance data databases, distribute to other computer devices or external sources such as a cloud-based server or the Internet.

In some embodiments, multiple computers may be connected through a server technology in order for multiple individuals to receive the same information instantly. This would be used during a sporting event so that announcers, production individuals, fans, players, coaches or commentators would be able to obtain information from the recent performance in real time. Such multiple computers would be configured to receive, transmit, compare to previously analyzed data, post to a cloud-based server or Internet and create visual TV quality graphics to be shown concurrent with video of the athletic event.

The computer processor may be preprogramed to analyze and export the data in terms of g-force, impact, impact force, total acceleration, initial acceleration. The user may also choose to represent performance data (e.g., height, ascent or descent angle, ascent or descent velocity, ascent or descent force, force in terms of strength required to stay in position, relative position, etc.) to visual data (e.g., spreadsheet, statistical report, graph, etc.) or video overlay graphic.

The present invention provides a method for collection, interpretation, analysis and visual display of performance data for better understanding, education, training, comparison and increased entertainment value by providing performance data in easy to understand visualized data and video graphics.

The present invention provides for collection, interpretation, analysis and visual display of performance data using the visualized data and video graphics to educate fans about the athletic ability required for the individual sport. For example, the data may be used by the Professional Bull Riders, Inc. during broadcast of events to describe to the viewers the g-forces experienced by the given bull rider.

The present invention provides for collection, interpretation, analysis and visual display of performance data so as to track performance of an athlete in order to evaluate whether they are improving and at what rate during an event, performance, race, practice or training session, in real-time or viewed later in tabulated spreadsheet and graphical form.

The present invention provides for collection, interpretation, analysis and visual display of performance data so as to score the athletic ability of the athlete in terms of acceleration, force, velocity, or any other quantifiable measure through the use of customized performance software which compares the athlete to other athletes at the same position in their athletic development. This may therefore be used, for example: during athletic scouting events; to determine the velocity and strength an athlete bench presses the bar; or to determine the force an animal kicks (i.e., by an animal athlete such as a bucking bull).

The present invention provides for collection, interpretation, analysis and visual display of performance data so as to compare the athletic ability of any given developing athlete in terms of acceleration, force, velocity through the use of customized performance software to a corresponding professional or elite athlete(s). Such comparisons may include analysis taking into account when the professional or elite athlete(s) were in the same position of athletic development as the developing athlete with or without regard to how many years difference there is in age.

The present invention provides for collection, interpretation, analysis and visual display of performance data so as to score, or otherwise quantify, athletic injuries in terms of acceleration, impact force, velocity at time of impact through the use of customized performance injury software. When compared to a collection of previous athletic wrecks/accidents and athlete's outcomes in terms of injury and recovery, this data may be used to determine the potential for serious injury. In other words, the data analysis may be used in a predictive manner.

The present invention provides for collection, interpretation, analysis and visual display of performance data so as to use the data collected to train and educate athletes so they may increase their athletic ability. By graphing or otherwise visually displaying the performance data, a coach, teammate, trainer, parent or athlete may visually see moments of weakness and areas needing improvement during the game, event or training session.

The present invention provides for collection, interpretation, analysis and visual display of performance data so as to use performance data to recreate athletic performance for training purposes. In such instances, the data may be overlaid upon video of ideal athletic positioning so the training athlete may, for example, see where mistakes may be occurring.

The present invention provides for collection, interpretation, analysis and visual display of performance data so as to provide more information to individuals investing in animal athletes by providing scientific performance data to a potential investor or individual looking to purchase the animal.

The present invention provides for collection, interpretation, analysis and visual display of performance data so as to recreate performance data in a hydraulic computer controlled device such as a mechanical bull. This would create a realistic mechanical bull ride that could be used as a training tool or entertainment.

In a first aspect, the present invention provides an apparatus for graphical athletic performance analysis, the apparatus including: at least one sensor module obtaining raw data corresponding to at least one quantifiable physical measurement obtained during an athletic performance; a processor including sensor data interpretation software for transforming the raw data into interpreted data; a data transmission mechanism for transferring the raw data from the sensor module to the processor; an output formed by the interpreted data; and storage of the interpreted data from one or more the athletic performance.

In a further aspect, there is provided an apparatus for graphical athletic performance analysis, the apparatus including: at least one sensor module obtaining raw data corresponding to at least one quantifiable physical measurement obtained during an athletic performance; a processor including sensor data interpretation software for transforming the raw data into interpreted data; a data transmission mechanism for transferring the raw data from the sensor module to the processor; an output formed by the interpreted data and provided to at least one member of an interested audience.

In still a further aspect, there is provided a system for collecting and analyzing computer interpreted performance data, the system including: at least one sensor module attached to an athlete, the module obtaining raw data corresponding to at least one quantifiable physical measurement obtained upon movement of the athlete during an athletic performance; a processor including sensor data interpretation software for transforming the raw data into interpreted data; a data transmission mechanism for wirelessly transferring the raw data from the sensor module to the processor; an output formed by the interpreted data and provided to at least one member of an interested audience.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of an athletic performance graphical system in accordance with one embodiment of the disclosed technology.

FIG. 2 is a generalized schematic of the athletic performance graphical system in use during a sporting event including collection, transmission, analysis, and exporting of data to the end user in terms of visual graphics during a sporting event.

FIG. 3 is one possible interface of the software program analyzing performance data from the sensor module.

FIG. 4 is an example output of the data compiled by the software program and performance data from the sensor module exported to the end user in terms of visual video graphics on a televised sporting event.

FIG. 5 is a generalized schematic showing an example of connected computers to display analyzed performance data from the sensor module.

FIG. 6 is an exemplary view of a report of analyzed performance data used score athletic performance in regards to one embodiment of the present invention.

FIG. 7 shows sensor modules placed within a protective bull riding vest.

FIG. 8 shows the general layout of a main sensor module.

FIG. 9 is a generalized schematic representation of a computer controlled hydraulic mechanical bull programmed to recreate a real bull ride from performance data.

### DETAILED DESCRIPTION

Generally, the present invention provides a system and apparatus for graphical athletic performance analysis.

The present invention includes an athletic performance graphical system for measuring any athletic performance. Moreover, the system may be utilized for tracking and comparing performance or increasing viewing audience by enhancing an audience's understanding of the given athletic performance. To accomplish this, the inventive system and apparatus informs the user of height, speed, velocity, force of impact or any other information that a user or audience member would want to gain from the athletic performance. For the purposes described herein, a user could be, but is not limited to, a participant wearing the device, event organizer, production assistant, a viewer watching the event in person or through other means such as television, a coach, an owner, etc. Although the following description is primarily directed to graphically show performance data such as changes in height, acceleration, changes in directions, etc., it will be appreciated that the stored data may be stored in the form of text or other alphanumeric codes that represent the information.

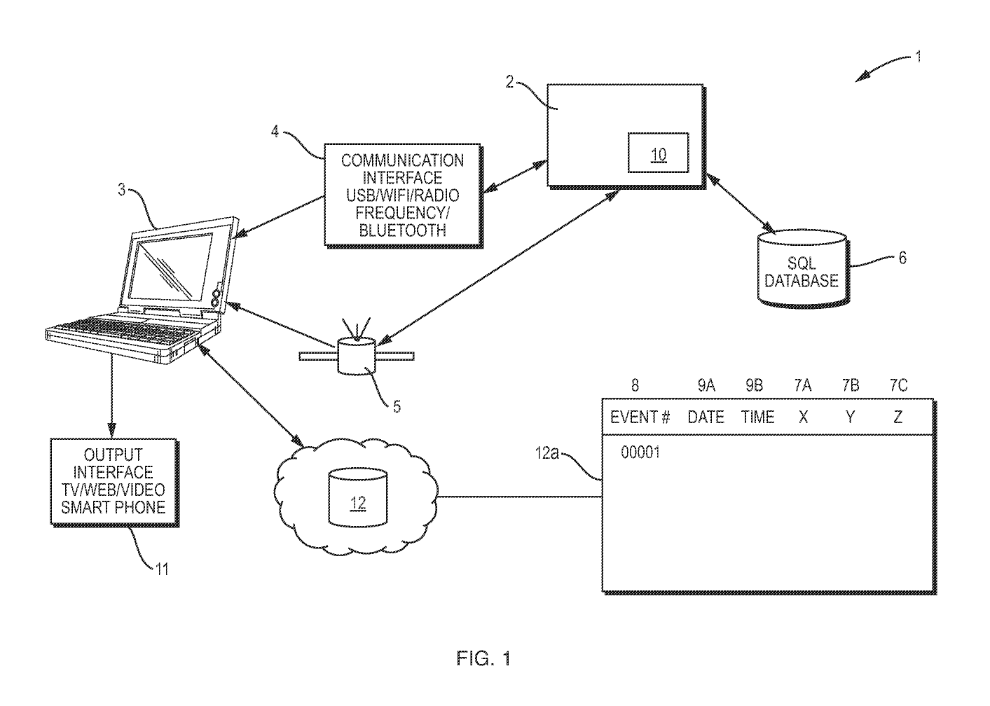

With regard to FIG. 1, there is shown generalized diagram of the system 1 in accordance with one embodiment of the present invention. The inventive system 1 includes at least one sensor module 2 which is placed on an athlete (not shown) in a manner described in more detail herein below. The sensor module 2 includes a memory device 10 (e.g., removable memory card) for storage of raw sensed data. It should be readily apparent that more than one such sensor module may be provided and that at least one such modules includes a memory device. Either in addition to or as an alternative to the memory device 10, the sensor module 2 is connected either wired or wirelessly to a storage database 6 used to store the raw sensed data. The sensor module 2 is also connected via a wireless communication interface 4 to a computing device 3 (shown as a laptop computer). An alternative interface between the sensor module 2 and the computing device 3 may be in the form of a secondary communication point 5 which may include a remote access point such as, for example, a satellite connection for situations where the given athlete may not be accessible by a standard local wireless interface. The computing device 3 includes a processor which is programmed to process the raw sensed data into a visual output 11. The computing device may additionally or alternatively be connected to a cloud-based server 12 that to store processed data in a tabulated form 12a and which would enable one or more other visual outputs. As one example of the specific data related to on implementation of the present invention, the processed data in tabulated form 12a may include an event number 8, date and time 9A and 9B, and the x, y, z coordinates 7A-7C.

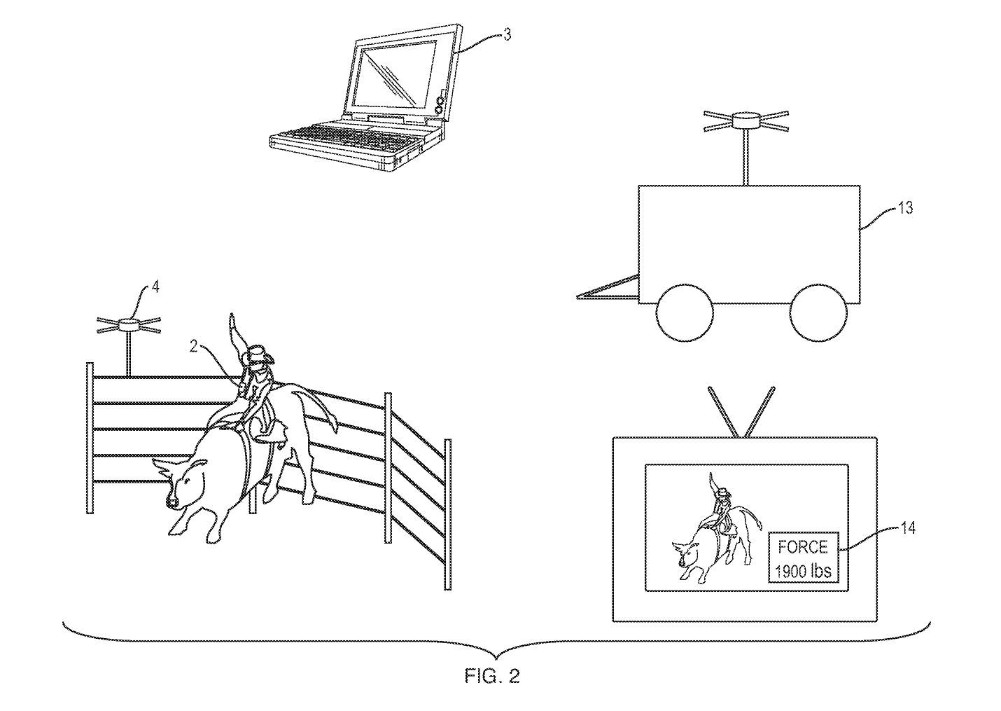

In operation of the system 1, one inventive embodiment is shown in FIG. 2 which includes placement of at least one sensor module 2 upon athletes (human or animal) by placing the sensor module(s) 2 on or within the athletes apparel (e.g., protective vest, bull flank strap, glove, shoes, etc.) or other sporting objects. It should be apparent that sensors placed directly upon athletes (human or animal) may be accomplished via sensors fabricated as adhesive patches or the like. Sporting objects may include equipment used by an athlete in the event, exercise equipment (e.g., weight bar, dumbbells, etc.) training equipment (e.g., mechanical bucking machine, weight sled, bucking bull dummy, etc.) or other object used by an athlete during an event or as a training tool to improve performance.

The embodiment shown in FIG. 2 includes one implementation of the present invention shown in terms of a bull riding event. Here, a sensor module 2 is placed on the vest of a bull rider. A wireless communication interface 4 such a radio relay may be used to wirelessly obtain raw sensed data from the sensor module and relay such data to a processor in the computing device 3. It should be readily apparent to one skilled in the electronic sensing art that the sensor module or modules may be used to collect a variety of raw data. More specifically, the sensor module(s) may be equipped technology to collected location and acceleration data, for example the sensor modules includes, a 3-axis accelerometer, a 3-axis gyroscope, a memory card recording module, and a transmission module. The raw data collected is then analyzed by the processor of the computing device 3 resulting in computed performance data such as acceleration, force, height, and/or change in velocity. In other words, the raw data is transmitted to a main computer (i.e., computing device 3) running customized sensor data interpretation software. Such computed performance data may then be exported to a visual medium such as TV graphics, and or a performance report, graph for example. In some embodiments, multiple 3-axis accelerometers and 3-axis gyroscopes may be place placed in multiple locations throughout the athlete or athletic equipment to gather additional data points.

With continued reference to FIG. 2, the data that is transmitted to the computing device 3 running the sensor data interpretation software may be recorded on a memory device such as, but not limited to, storage cards such as a micro SD card or over a wireless connection using Bluetooth, Wi-Fi or cellular connection or equivalent technology to a server storage device. As mentioned, the data is then be analyzed and interpreted for (e.g., acceleration, velocity, impact force, strength, change in direction, etc.). The analyzed data is then exported based on the user's needs. Exporting options may include TV quality graphics exported to TV production truck 13 to be used in during live sporting events, performance spread sheet, performance analyze graphic, written performance report, etc. An example of a visual graphic display of the event with an informational overlay is shown as an exemplary screenshot 14. It should be readily apparent that connections among the elements shown in FIG. 2 may be a combination of wired and wireless connection as appropriate.

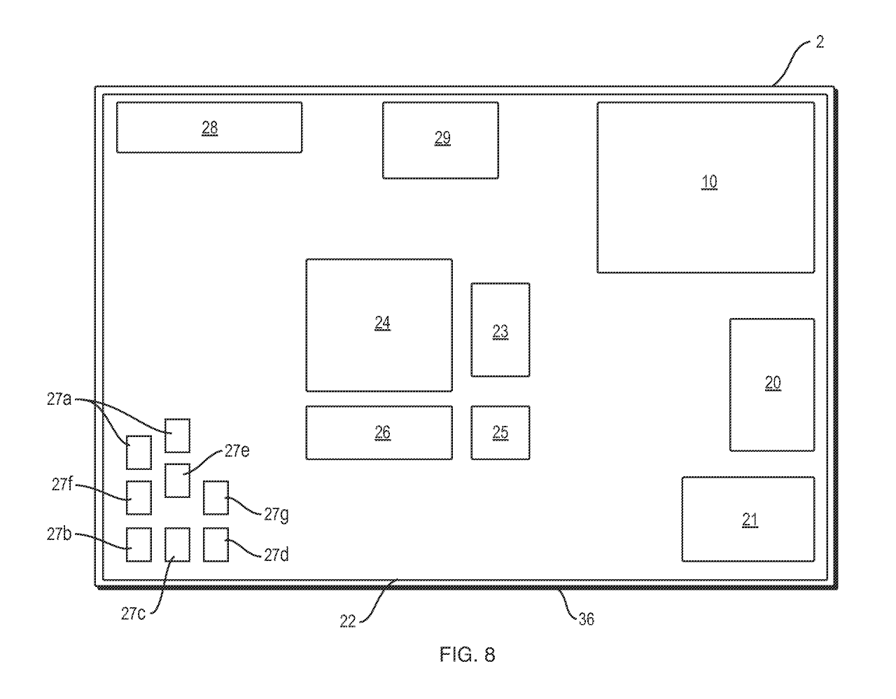

With regard to FIG. 8, one possible configuration of the components of a sensor module 2 is shown. Here, the sensor module 2 generally is configured include a 3-axis accelerometer 24, 3-axis gyroscope 23, control electronics 26, LED status lights 27a through 27g, battery 25, USB connection 21, memory 10, power switch 28, recording switch 29, command switch 20 all mounted on a circuit board 22 and contained within a housing 36. As previously discussed, it should be understood that the USB connection 21 may be alternatively substituted with a wireless connection (e.g., cellular, Wi-Fi, or Bluetooth radio device) without straying from the intended scope of the invention. Further, the USB connection 21 may simply utilize a USB-connectable wireless attachment (e.g., Wi-Fi dongle).

The 3-axis accelerometer 24 may be a model ADXL377 available from Analog Analog Devices, Inc. of Norwood, Mass. or any equivalent. Likewise, the 3-axis gyroscope 23 may be a model ADXRS652 available from Analog Devices, Inc. of Norwood, Mass. or any equivalent. Recordings of raw data are obtained from the 3-axis accelerometer 24 and the 3-axis gyroscope 23 via control electronics 26 so as to record acceleration and 3-axis gyroscope position in terms of x, y, and z coordinates. The sensor module 2 obtains position point recordings 500 times a second and is configured to automatically write the data points to memory 10 along with transmitting the data over the communication interface to the sensor data interpretation software resident on the given computing device (e.g., laptop as shown in FIG. 1).

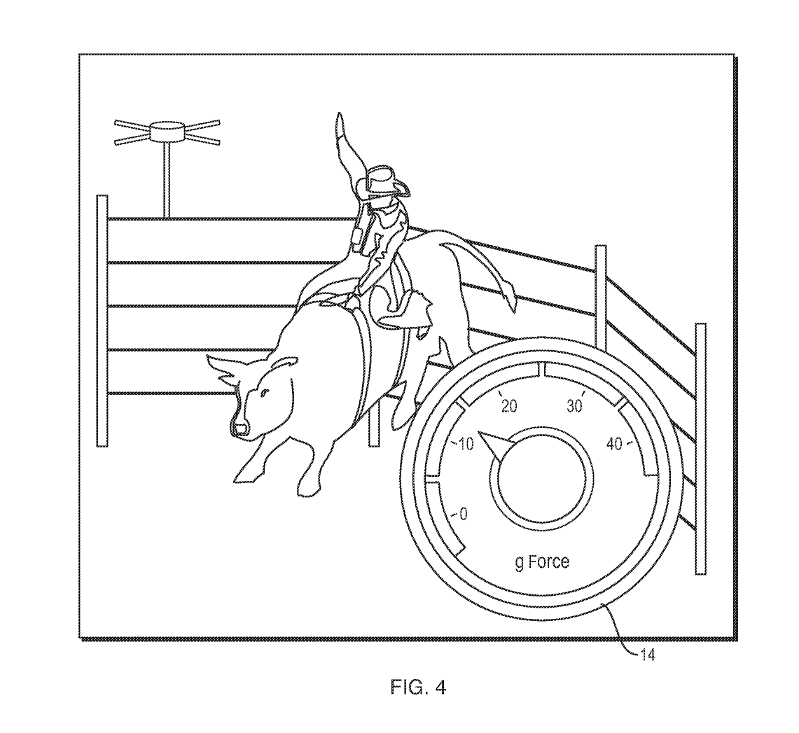

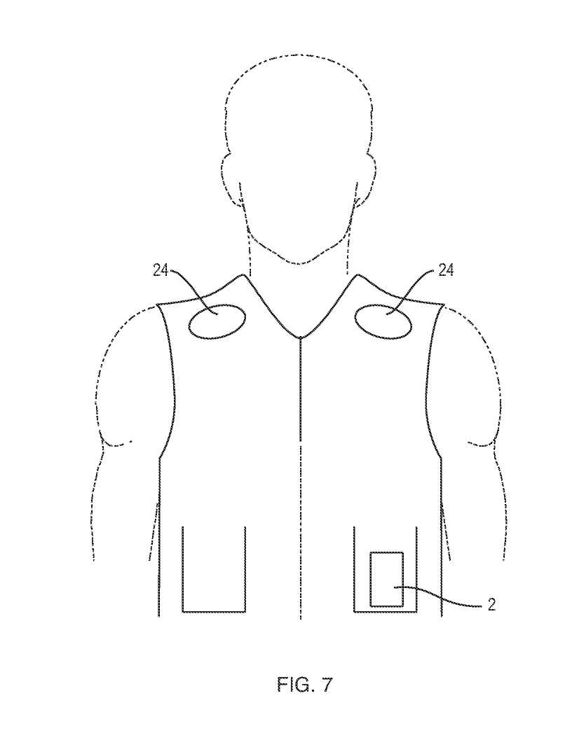

As already suggested, additional sensor modules will be required in some embodiments. Likewise, a sensor module and additional sensors may be used in any given implementation. Once such example is shown in FIG. 7 where a main sensor module 2 is provided in the vest of a user along with two 3-axis accelerometers 24. In this manner, a combination of raw data may be obtained from a first location on the torso of a bull rider, from a second location on the head or hat of the bull rider, and also from a third location on bucking bull. In this manner, useful raw data may be obtained from a bucking bull event that may be utilized to generate a visual overlay of computed information on the corresponding video which, for example, shows the g-forces subjected to the rider upon back and forth motion or the acceleration of the bulking bull. One such example of this is seen by way of FIG. 4 which shows a bucking bull event overlaid by a graphical indication of g-force 14 which may vary in real-time as a dynamic g-force meter thus enhancing the viewer's experience and conveying useful real-time event data.

The sensor module 2 is turned on and off using the power switch 28. The control electronics 26 may be programmed to automatically turn off the sensor module 2 after a determined period of time of no activity (i.e., sleep mode) and turned on within a predetermined level of motion (i.e., wake mode). The sensor module 2 may also be forced to sleep mode using the command switch 20. Likewise, the control electronics 26 may be programmed to automatically turn off the sensor module 2 after a user selected period of time, wake and record, to transmit during a specific date and time, or other user determined parameter.

The sensor module 2 begins to record (i.e., store raw data in memory) when the user presses the record switch 29. This activates the sensor module 2 so as to record, write, and transmit data via the communication interface 4 to the computing device 3. The record switch 29 also records the initial position in x, y, z coordinate form to provide a calibration point for the sensor data interpretation software within the computing device 3. The sensor module 2 may also be calibrated and baseline position marked remotely by using the sensor data interpretation software via wireless communication.

The sensor module 2 is configured to record to internal memory 10 such as a micro SD card or equivalent. The control electronics 26 of the sensor module 2 may be programmed to record data points on an internal removable memory card 10 such as a micro SD or equivalent or on an external database (shown for example as a remote storage database 6 in FIG. 1).

The sensor module 2 can also be configured to transmit data over any suitable communication interface. This may include, without limitation, Bluetooth, Wi-Fi, or cellular connection. Thus, the sensor module 2 may be configured to include electronics suitable for any such wireless transmission of data so as to enable real-time connection of the sensor module 2 to the sensor data interpretation software within the computing device 3. Notwithstanding the desirability of wireless data transmission, it should be readily apparent that data may also be transferred to the sensor data interpretation software by importing the removable memory and its related stored raw data into the sensor data interpretation software by physical removal and reconnection. Likewise, the sensor module 2 may also be equipped with a USB connection 21 to allow direct data transfer to the sensor data interpretation software of the computing device 3.

The sensor module 2 may be equipped with multiple LED status lights 27a through 27g used to allow the user quick interpretation of operation of each element and/or function within the sensor module 2. The meaning of each LED status light may or course vary in accordance with the given sensing electronics residing within the sensor module 2 for the given implementation and will be governed by the control electronics 26.

By way of example, the control electronics 26 may be programmed to flash a particular LED light or perhaps a given sequence of LED lights when position recording is taking place. The control electronics 26 may be programmed to flash an LED light when the device is powered. The control electronics 26 may be programmed to flash an LED light when the battery on the device is running low. Still further, an LED light may be programmed to flash once to represent 25% battery power remaining, flash twice to represent 10% battery power remaining and remain lit to represent less than 5% remaining. Numerous other variations may of course be possible without straying from the intended scope of the present invention.

The control electronics 26 of the sensor module 2 may also be programmed to automatically save data recordings to internal memory 10 or, alternatively, transmit via the communication interface 4 to external data storage when battery power has reached 1% to ensure that data is not lost. The sensor module 2 may also be programmed to automatically turn off when battery power is below 0.5%.

The sensor module 2 is powered by a battery 25 such as, but not limited to a lithium polymer battery or equivalent.

The sensor module 2 is housed in a housing 36 which may be formed from a suitably durable and high impact plastic. In one embodiment, the sensor module 2 and housing 36 may be positioned in a molded holder (not shown) in order to provide stable data collection when placed within the pocket of a protective bull rider vest.

As previously stated, raw data from the sensor module 2 is transferred to the sensor data interpretation software in the computing device 3 for analysis. Data is transferred from the sensor module 2 in real-time through the communication interface 4. The communication interface 4 may be configured to transmit data via any one or combination of communications protocols including, without limitation, Bluetooth communication, cellular communication, Zigbee, or wireless Internet communication such as Wi-Fi for example. The communication interface 4 may also be enabled to upload data to an offsite or cloud-based server 5 and therefore stored as remote data storage. The remote data storage may serve as a backup file storage or for retrieval by remotely located sensor data interpretation software at one or more differing computing devices. It should therefore become readily apparent that the sensor data interpretation software may analyze the raw data from unlimited distance away from the event via, for example, a satellite-based Internet connection. This may of course be quite useful in any given implementation whereby the sensor data interpretation software may be unable to be located within wireless range of the sensor module.

In some embodiments, accumulated raw data may be transferred from the sensor module 2 to the sensor data interpretation software of the computing device 3 through USB or equivalent technology such as a so-called “thumb drive” or “memory stick.” In such an embodiment, the stored date in memory 10 from the sensor module 2 would be therefore manually provided to the sensor data interpretation software 3 through USB or equivalent technology.

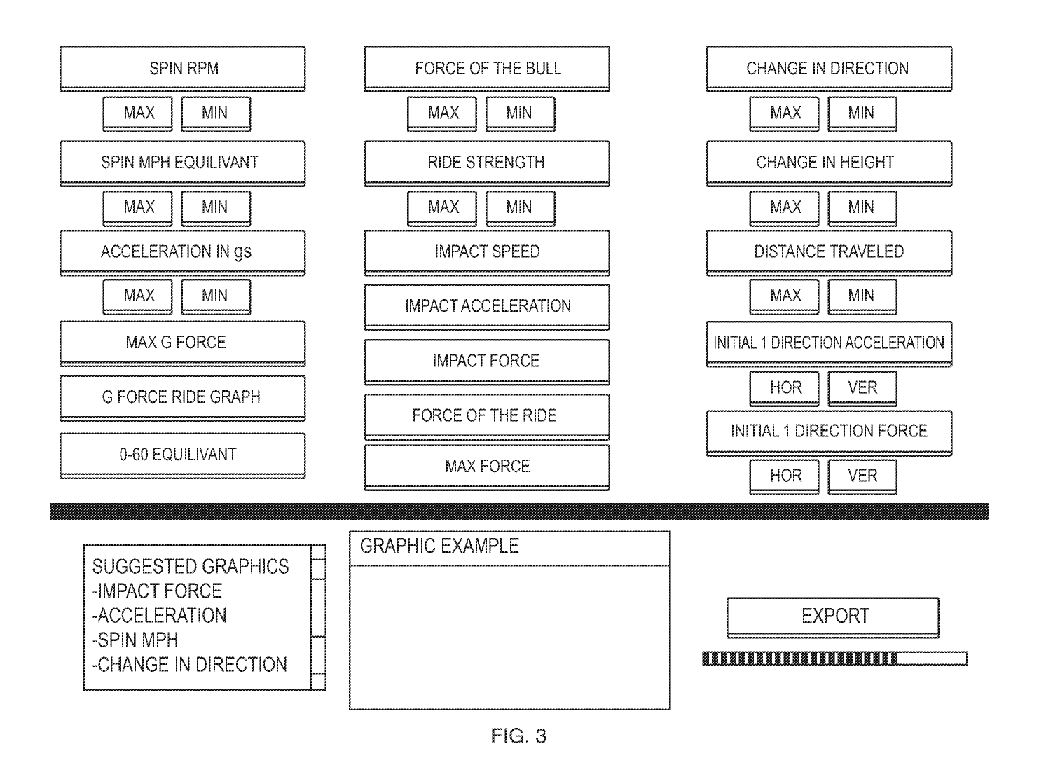

With regard to FIG. 3, there is shown a block diagram including functional blocks of the sensor data interpretation software. Such sensor data interpretation software within the computing device 3 compiles the acceleration data, vector points and velocity in accordance with customizable software. For example, the user is able to determine the statistical performance outcome from the related functions they want the sensor data interpretation software to compute. For example, the sensor data interpretation software may be programmed to compute force, acceleration, or falling velocity. The sensor data interpretation software may also be programmed to compute many different statistical performance outcomes from the raw data (e.g., force, acceleration, velocity, speed, rpm, acceleration force, lifting force, running force, performance force, change in direction, change in direction force, height, jump, vertical, angle of decline, angle of accent, accent speed, terminal velocity, impact force, impact speed, etc.) It should of course be understood that some additional or different sensing devices may of course be required within the sensor module for obtaining different raw data for certain ones of the many different statistical performance outcomes.

Still further, the sensor data interpretation software may be programmed to record event information (e.g., player name, event name, location, time, outcome, etc.) along with raw sensor module data. The sensor data interpretation software may be programmed to save event information within performance data to be used for recall, sorting, review or exporting. Likewise, the sensor data interpretation software may be programmed to import athlete data (statistics, schedule, height, weight, etc.) from outside websites, spreadsheet files, or equivalent sources.

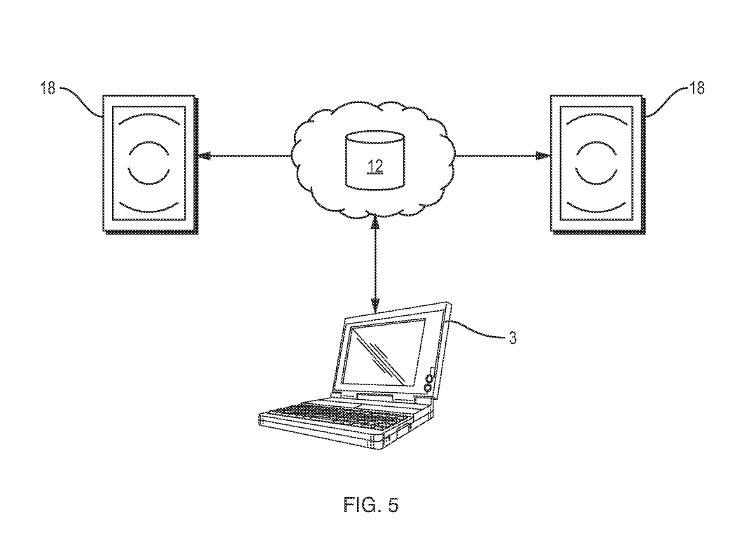

As previously mentioned, the sensor data interpretation software may be programmed to upload the raw and/or computer-interpreted performance data to a remote or cloud server. FIG. 5 illustrates one embodiment whereby the cloud server 12 that act to relay the computer interpreted performance data from the computing device 3 to other computer-related devices 18. These other computer-related devices 18 may include laptops, smart phones, tablet computers, or any other such computing element. Still further, the cloud server 12 may be programmed to allow external computers (e.g., remotely located 3^{rd} party computing device) also equipped with the sensor data interpretation software to access the raw event data. Depending upon the level of security required, using a mechanism (e.g., password protection) may be desirable to verify the appropriate user information. Alternatively for example, performance data could be accessed with only the sensor data interpretation software's electronic signature.

The sensor data interpretation software may also be programmed to send computer interpreted performance data automatically to an interested audience (e.g., a fan, coach, player, announcer, official, etc.) in text message or SMS form, email or equivalent technology. In more urgent or time-sensitive situations, the sensor data interpretation software may be programmed to send data instantly to be used by such interested audience in real-time sporting events for announcing, reporting or explaining the action.

The sensor data interpretation software may be programmed to export interpreted data to TV or event production technology in order for the data to be displayed on a TV screen, in area screens, live or taped delayed broadcasts, etc. As seen in FIG. 4, the sensor data interpretation software may be programmed to include graphics to represent interpreted data such as force, strength, acceleration, etc. whereby interpreted sensor data displayed through the sensor data interpretation software generated graphic is then broadcasted along with the event to the end user. The given graphic is designed to digital broadcast standards. The sensor data interpretation software may also be programed so that graphics match size, color and shape for a seamless transition from the sensor data interpretation software to the televised production.

In another embodiment, the sensor data interpretation software may be programmed to export interpreted data as a performance graph. The graph may be intended for only on screen display or provided in a printable form. Such graph may be in any readily interpretable graphical format such as, but not limited to, wave graphs, pie charts, plotted points, or bar graphs. In such graphing, multiple computer interpreted performance data is compiled in order to compare different performances. The sensor data interpretation software may be configured to export data based on a specific player, event, date range, event outcome, performance level, etc.

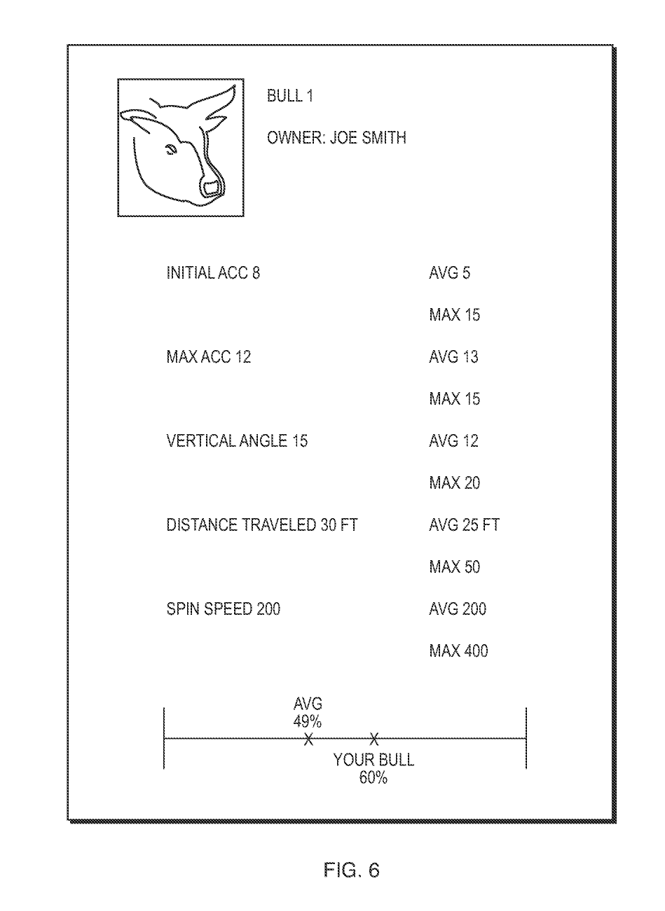

In another embodiment, the sensor data interpretation software may be programmed to export interpreted data as a performance report. Again, such report may be in either an on-screen or physical printed version. As illustrated in FIG. 6, one example of an athlete's performance exported in a report. The sensor data interpretation software may be programmed using an additional rating analysis to grade or otherwise rate the athlete's performance against other athletes or an average as shown. Ratings may, for example, include athletes the same age or previously collected data from older athletes or any related sampling.

The sensor data interpretation software may be programmed with a predictive analysis to predict the performance growth track of the athlete. Using the sensor data collected and comparing key athletic identifiers (e.g., acceleration, force, initial acceleration, etc.), the coach, player, owner, etc. could measure the performance growth trajectory of the athlete. This would be important, for example, to college coaches during the recruiting process, professional teams when evaluating an athlete and for an animal athlete when an investor is looking to purchase an animal athlete such as a bucking bull or race horse.

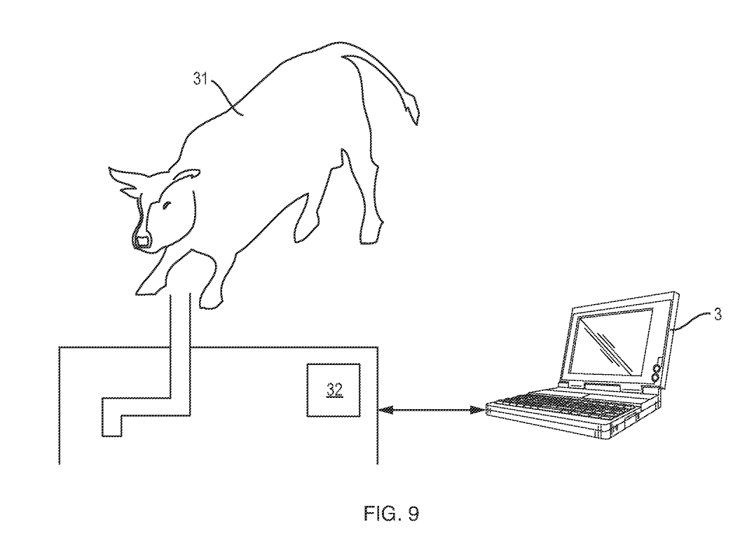

In another alternative embodiment the sensor data is used as a training tool by recreating an athletic performance. In one such implementations, the sensor data interpretation software may be programmed to export sensor data as a computer data points that are be interpreted by a computer controlled hydraulic system such as, but not limited to, a computer controlled hydraulic mechanical bull. In such a mechanical bull implementation as illustrated in FIG. 9, the sensor data interpretation software resident in the computing device 3 is connected to the control box 32 of a mechanical bull 31. The sensor data interpretation software may therefore be used to recreate any ride from historical computer interpreted performance data gathered during a past event. The sensor data interpretation software may also be programmed to export the ride data, and thereby recreate a past event, in varying level of difficulty that allow the rider to practice for example in a realistic yet slower speed, lower g-force, slower change of direction, etc.

In another embodiment, the sensor module may be embedded into an artificial rider mechanism for attachment to a real bucking bull. The mechanism is formed by a data gathering box including the sensor module. The box is attachable to a bull via a releasable cinch strap. The cinch strap would be configured to release upon a predetermined trigger. In this manner, the artificial rider acts as a cowboy proxy in order to gather data and emulate a realistic ride by a real cowboy. The software controlling the releasable cinch strap is programmable to interpret the sensor module data in order to emulate a realistic cowboy's performance. In other words, the software would release the cinch strap that secures the artificial rider on the bull when the bull's performance surpasses the ride event parameters and a realistic rider's ability. In determining the ability of a cowboy to remain in control on top of the bull, the ride event parameters would consist of a collection of historical ride data from the sensor data interpretation software as previously discussed. It should therefore be readily apparent that the software controlling the releasable cinch strap may be programmed with historical ride data so as to provide multiple ride parameters to represent different levels and rider ability.

In another embodiment, the sensor data interpretation software may be programmed with a predictive analysis to predict the risk of injury during an athletic mishap or accident. The sensor data interpretation software may therefore be programmed to include predictive injury software that utilizes a combination of Center for Disease Control (CDC) injury severity predictions along with previously injured (i.e., historical) athlete sensor data to produce an injury score. The sensor data interpretation software may be programmed to automatically and in real-time alert event medical staff. Such alerts would occur through a suitable broadcast mechanism (e.g., SMS, text message, email, etc.) when the sensor module data produces data that correlates to a high injury score.

As will be appreciated from the above, the inventive system and apparatus provides an elegant solution for users to obtain information and measure improvement of any athletic performance. The stored data is held private with access only upon proper identification of the user such as by the submission of a user number and, if desired, submission of one or more passwords.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An apparatus for graphical athletic performance analysis, said apparatus comprising:
at least one sensor module obtaining raw data corresponding to at least one quantifiable physical measurement obtained during an athletic performance;
a processor including sensor data interpretation software for transforming said raw data into interpreted data;
a data transmission mechanism for transferring said raw data from said sensor module to said processor;
an output formed by said interpreted data and provided to at least one member of an interested audience.

2. The apparatus as claimed in claim 1 wherein said sensor module includes a memory device and at least one sensing device.

3. The apparatus as claimed in claim 1 wherein said sensor module includes a memory device and one or more one sensing devices for capturing said raw data corresponding to force, acceleration, velocity, and change of direction of an athlete during said athletic performance.

4. The apparatus as claimed in claim 3 wherein said output includes a graphical display of said interpreted data.

5. The apparatus as claimed in claim 4 wherein said graphical display of said interpreted data is configured for broadcasting.

6. The apparatus as claimed in claim 5 wherein said broadcasting includes real-time video display of said athletic performance and said graphical display is overlaid upon said video display.

7. The apparatus as claimed in claim 4 wherein said broadcasting includes real-time communications via a broadcast mechanism selected from a group consisting of short message service, text messaging, and electronic mail.

8. The apparatus as claimed in claim 7 wherein said sensor data interpretation software includes predictive injury software that compares said interpreted data with a combination of injury severity predictions and previously injured athlete sensor data to produce an injury score.

9. The apparatus as claimed in claim 8 wherein said injury score is communicated by said broadcast mechanism to emergency personnel.

10. The apparatus as claimed in claim 4 wherein said sensor data interpretation software includes predictive injury software that compares said interpreted data to previously stored athlete sensor data to produce a relational output forming an athlete rating scheme.

11. The apparatus as claimed in claim 10 wherein said apparatus includes real-time communications of said relational output forming an athlete rating scheme to said interested audience via a broadcast mechanism selected from a group consisting of short message service, text messaging, and electronic mail.

12. An apparatus for graphical athletic performance analysis, said apparatus comprising:
at least one sensor module obtaining raw data corresponding to at least one quantifiable physical measurement obtained during an athletic performance;
a processor including sensor data interpretation software for transforming said raw data into interpreted data;
a data transmission mechanism for transferring said raw data from said sensor module to said processor;
an output formed by said interpreted data; and
storage of said interpreted data from one or more said athletic performance.

13. The apparatus as claimed in claim 12 wherein said sensor module includes a memory device and one or more one sensing devices for capturing said raw data corresponding to force, acceleration, velocity, and change of direction of an athlete during said athletic performance.

14. The apparatus as claimed in claim 13 wherein said storage of said interpreted data occurs remote from said athletic performance.

15. The apparatus as claimed in claim 14 wherein said output is transformed into simulation commands.

16. The apparatus as claimed in claim 15 wherein simulation commands are used in a device for duplicating effects of said raw data.

17. The apparatus as claimed in claim 15 wherein said athletic performance is a real-life bull-riding event and said simulation commands are used to operate a mechanical bull-riding device.

18. A system for collecting and analyzing computer interpreted performance data, said system comprising:
at least one sensor module attached to an athlete, said module obtaining raw data corresponding to at least one quantifiable physical measurement obtained upon movement of said athlete during an athletic performance;
a processor including sensor data interpretation software for transforming said raw data into interpreted data;
a data transmission mechanism for wirelessly transferring said raw data from said sensor module to said processor;
an output formed by said interpreted data and provided to at least one member of an interested audience.

19. The system as claimed in claim 18 wherein said output includes a graphical display of said interpreted data configured for broadcasting and said system includes real-time video display of said athletic performance wherein said graphical display is overlaid upon said video display.

20. The system as claimed in claim 18 wherein said interpreted data is configured for broadcasting and said system includes real-time communications via a broadcast mechanism selected from a group consisting of short message service, text messaging, and electronic mail so as to broadcast said interpreted data to said at least one member of said interested audience.
